(19) United States
(12) Patent Application Publication
(10) Pub. No.: US 2018/0167147 A1
(43) Pub. Date: Jun. 14, 2018

(54) DEVICE AND METHOD FOR ULTRASONIC COMMUNICATION

(71) Applicant: Intel Corporation, Santa Clara, CA (US)

(72) Inventors: Matias Almada, Columbus, GA (US); Xintian Eddie Lin, Mountain View, CA (US)

(21) Appl. No.: 15/378,299

(22) Filed: Dec. 14, 2016

(51) Int. Cl. H04B 11/00

(52) U.S. Cl. CPC H04B 11/00

(57) ABSTRACT

This disclosure relates to an ultrasonic communication device, comprising: an adjustable ultrasonic transmitter, configured to transmit an ultrasonic communication signal according to a first transmission scheme or according to a second transmission scheme; a microphone, configured to generate an audio signal, wherein the audio signal comprises audible artifacts which are based on nonlinearities in the transmission of the ultrasonic communication signal; and a controller, configured to adjust the ultrasonic transmitter based on the audio signal.

### FIELD

The disclosure relates to a ultrasonic communication device and a method for ultrasonic communication. The disclosure particularly relates to techniques for minimizing audible artifacts for device to device ultrasonic communications.

### BACKGROUND

Proximity provisioning can be enabled through ultrasonic communications 102 between PCs, laptops, tablets or phones as shown in FIG. 1a. A software library such as “Intel tone” may be used to exchange short messages 102 (up to 64 bit packets) between client devices 101, 103 via ultrasound (Data over Ultrasound). Data is encoded in sound buffers using a modified DTMF mapping with modern communication techniques with high frequency tones, inaudible to the human ear. However, due to various speaker component designs 103, 104 and audio codec architectures, such ultrasonic transmissions 102 may produce audible artifacts 114, negatively impacting the user experience as shown in FIG. 1b. Speaker components 103, 104 and audio codecs in today's devices are designed for optimizing the audible experience. Designs may not be optimized for the ultrasound 113 and near ultrasound (18 KHz+) range. Audible noise may be generated 114 due to nonlinearities in amplifiers/speakers 103, 104 at high frequencies. Some TV devices 101 for example usable as teleconference servers suffer from such artifacts 114.

Hence, there is a need to improve ultrasonic communication, in particular with respect to the above described deficiencies in order to improve audible experience.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description.

FIG. 1a is a schematic diagram illustrating an ultrasonic communication system 100 implementing proximity provisioning.

FIG. 1b is a frequency diagram illustrating frequency ranges for infrasound 111, acoustic 112 and ultrasonic 113 communications.

FIG. 2 is a schematic diagram illustrating an ultrasonic communication system 200 with DTMF tone mixing and stereo reinforcement of mono channel.

FIG. 3 is a schematic diagram illustrating an ultrasonic communication system 300 with DTMF tone isolation per channel according to the disclosure.

FIG. 4 is a schematic diagram illustrating an ultrasonic communication system 400 according to the disclosure.

FIG. 5 is a schematic diagram illustrating a Gray code mapping and DTMF decoding table 500 for generating DTMF modulated ultrasonic communication signals according to the disclosure.

FIG. 6 is a schematic diagram illustrating a method 600 for ultrasonic communication according to the disclosure.

FIG. 7 is a schematic diagram illustrating a method 700 for ultrasonic communication according to the disclosure.

### DETAILED DESCRIPTION

In the following detailed description, reference is made to the accompanying drawings, which form a part thereof, and in which is shown by way of illustration specific aspects in which the invention may be practiced. It is understood that other aspects may be utilized and structural or logical changes may be made without departing from the scope of the present invention. The following detailed description, therefore, is not to be taken in a limiting sense, and the scope of the present invention is defined by the appended claims.

The following terms, abbreviations and notations will be used herein:

### DTMF: Dual Tone Multiple Frequency

### HDMI: High Definition Multimedia Interface

The systems, methods and devices described herein may be based on ultrasonic or ultrasound communication. Ultrasound is defined by the American National Standards Institute as “sound at frequencies greater than 20 kHz”. Ultrasonic or ultrasound are sound waves with frequencies higher than the upper audible limit of human hearing. Ultrasound is no different from normal, i.e. audible sound in its physical properties, except in that humans cannot hear it. This limit varies from person to person and is approximately 20 kilohertz in healthy, young adults. Ultrasound devices operate with frequencies from 20 kHz up to several Giga Hertz. Ultrasound is used in many different fields. Ultrasonic devices are used to detect objects and measure distances.

The systems, methods and devices described herein may be based on conference servers and software implementing conferencing, e.g. such as Intel Tone that is a system and method supporting Smart Office conference rooms. It is a method of provisioning attendee's mobile devices to the room's peripherals, such as wireless displays or phone/loudspeakers. The ultrasound proximity software is installed on a NUC (Next Unit of Computing) connected to a TV. By removing the audible noise caused by some audio configurations, the adaptive transmission algorithm allows for flexibility in selection of any TVs to use in conference rooms.

It is understood that comments made in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

The techniques described herein may be implemented in wireless communication networks, in particular communication networks based on high speed communication standards from the 802.11 family according to the WiFi alliance, e.g. 802.11ad and successor standards. The methods are also applicable for mobile communication standards such as LTE, in particular LTE-A and/or OFDM and successor standards such as 5G. The methods and devices described below may be implemented in electronic devices such as mobile or wireless devices (or mobile stations or User Equipments (UE)). The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense.

The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

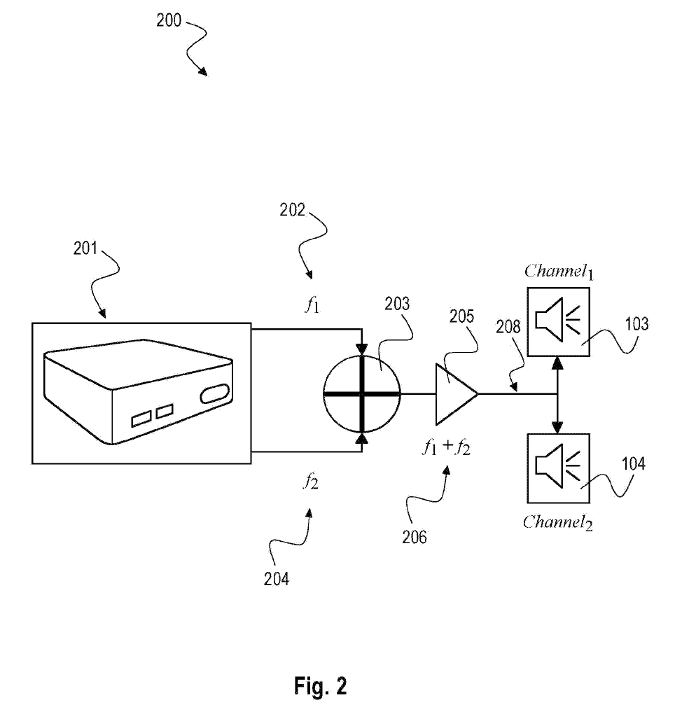

FIG. 2 is a schematic diagram illustrating an ultrasonic communication system 200 with DTMF tone mixing and stereo reinforcement of mono channel.

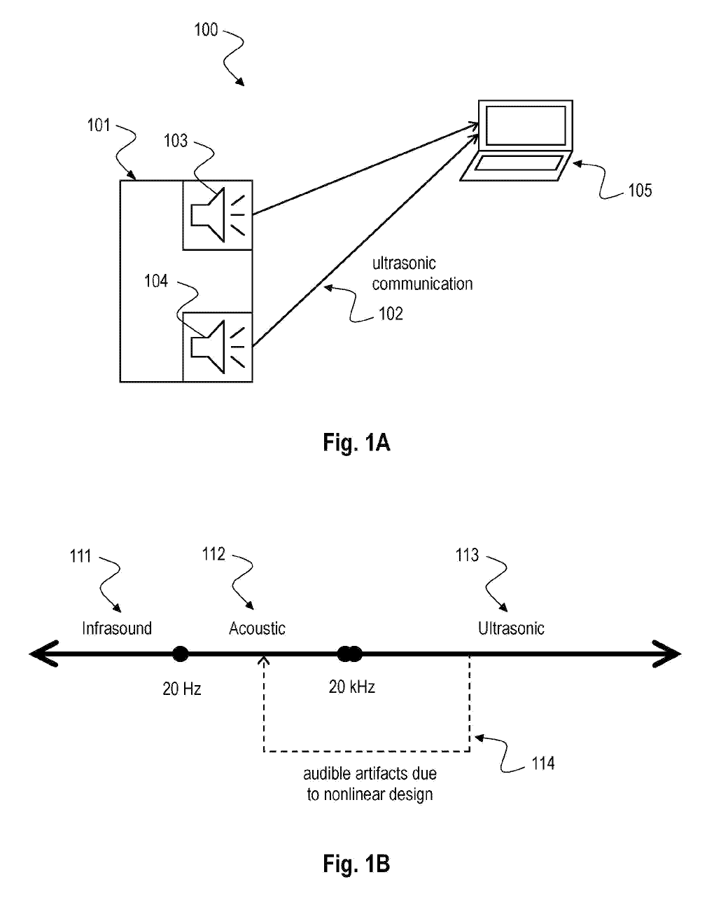

The preferred transmission system 200 or method of transmission as shown in FIG. 2 includes audio mixing 203 and two channel reinforcement, e.g. by using amplifier 205, of a mono signal 208. Both tones 202, 204 required to form a data symbol are superimposed 206 and transmitted through both left 103 and right 104 channels. Assuming a receiving client device, such as a laptop 105 depicted in FIG. 1, has two-channel microphone, this method provides fourth order diversity. There are four paths for which the ultrasonic signals to travel from transmitter 201 to receiver 105. Thus, this method has increased resilience to path obstruction & fading. However, due to the tone mixing 203, the signal's RMS value drops by a factor of 4 and a peak to average power ratio of 6 dB:

$${x}_{rms} ( t ) = \frac{1}{T} {\int }_{0}^{T} {[ \frac{1}{2} sin ( 2 π {f}_{1} t ) + \frac{1}{2} sin ( 2 π {f}_{2} t ) ]}^{2} dt = \frac{1}{4}$$

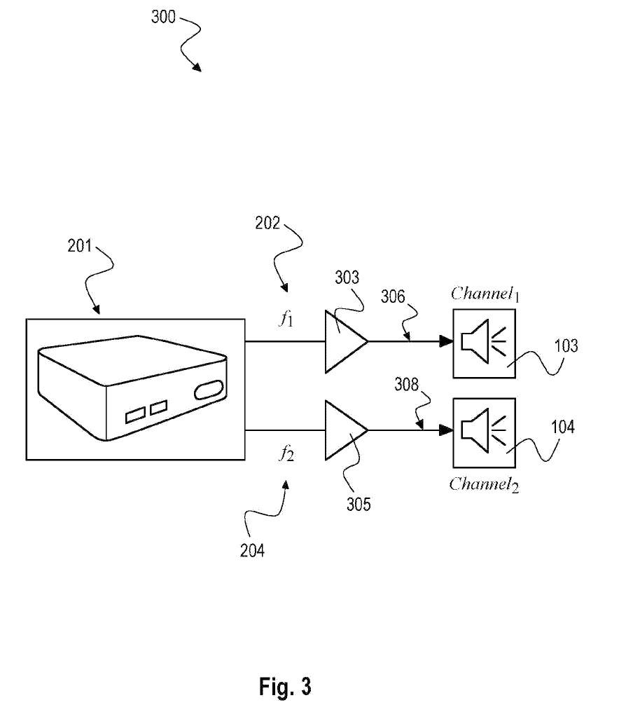

A pilot packet would first be sent with this method, as the 4^{th} order diversity combats the variations in uniformity of coverage and assuming conference attendee's seat are centralized in front of the TV, the identical signals arrive from the two channels at similar times. This pilot tone will be transmitted and recorded simultaneously. Because this method tends to cause audible artifacts ranging from 4-12 kHz from the mixing tones in 18-20 kHz range (intermodulation distortion), if the recorded pilot tone contains significant energy from audible frequencies, this method would not be acceptable for users, and an alternative pilot packet will be played. The alternative packet transmits one tone through the left channel 103, and the other tone through the right channel 104 as illustrated in FIG. 3.

FIG. 3 is a schematic diagram illustrating an ultrasonic communication system 300 with DTMF tone isolation per channel according to the disclosure.

This transmission system 300 or method of transmission isolates the tones 202, 204 per channel 103, 104, avoiding intermodulation distortion, which eliminates audible artifacts in some audio systems. What is lost in having 2^{nd} order diversity is gained in signal RMS of one half and a lower peak to average power ratio by 3 dB.

$${x}_{rms} ( t ) = \frac{1}{T} {\int }_{0}^{T} {sin}^{2} ( 2 π f ) dt = \frac{1}{2}$$

Such an algorithm enables a larger range of manufactures of audio equipment the ability to effectively adopt device to device communication in the ultrasonic audio band. Separate amplifiers 303, 305 may be used per tone 202, 204 and audio channel 103, 104.

A NUC 201 or any other software solution may be used to generate the tones 202, 204. The NUC may be connected to any TV with HDMI, with ultrasound proximity provisioning. Guests may be enabled not on the same Wi-Fi network to share content to the TV. The algorithms described above may run on a Tele Presence hardware, e.g. a NUC 201.

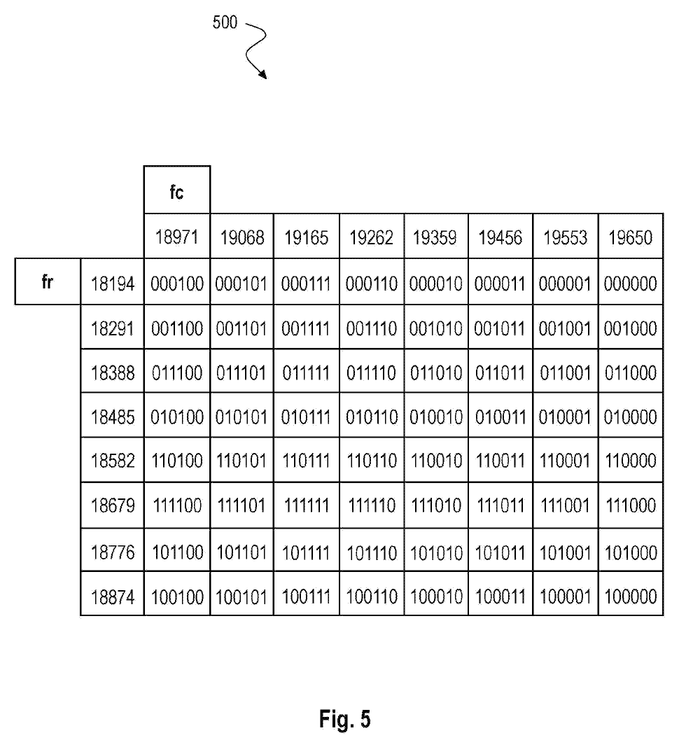

In the following, an exemplary implementation of such an ultrasonic communication system 300 is described. The ultrasonic communication system 300 includes an audio codec to encode data based on dual tone multiple frequency (DTMF) modulation, e.g. as described below with respect to FIG. 5, to generate a first ultrasonic tone 202 and a second ultrasonic tone 204 of an ultrasonic communication signal 306, 308. The ultrasonic communication system 300 further includes an ultrasonic transmitter, e.g. formed by the loudspeakers 103, 104, to transmit the first ultrasonic tone 202 via a first acoustic channel and the second ultrasonic tone 204 via a second acoustic channel to mitigate audible artifacts which are based on nonlinearities in the transmission of the ultrasonic communication signal 306, 308.

The ultrasonic transmitter thus isolates the first ultrasonic tone 202 from the second ultrasonic tone 204 to avoid intermodulation distortion. The ultrasonic transmitter may transmit the first ultrasonic tone 202 and the second ultrasonic tone 204 simultaneously.

The ultrasonic transmitter may include a first amplifier 303 and a first loudspeaker 103 to transmit the first ultrasonic tone 202 using a first ultrasonic communication signal 306. The ultrasonic transmitter may include a second amplifier 305 and a second loudspeaker 104 to transmit the second ultrasonic tone 204 using a second ultrasonic communication signal 308.

The NUC 201, the amplifiers 303, 305 and loudspeakers 103, 104 may be implemented in an ultrasonic communication device, e.g. a stereo TV which may serve as a conference server, communicating with a mobile device 105 by ultrasonic communication 102, e.g. as shown in FIG. 1. The stereo TV may playout the first ultrasonic tone 202 through the first loudspeaker 103 and the second ultrasonic tone 204 through the second loudspeaker 104. The ultrasonic communication device may include an external interface to receive the data to be DTMF encoded. The external interface may include a High Definition Multimedia Interface (HDMI) connection. The ultrasonic communication signals 306, 308 may include a personal identification number (PIN) for identifying a user of the mobile device 105 with the stereo TV.

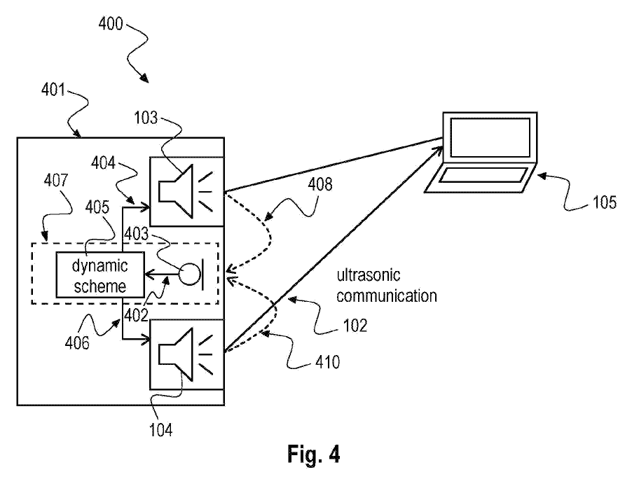

The configuration shown in FIG. 3 efficiently avoids generation of audible artifacts due to isolation of both ultrasonic tones 202, 204 in separate acoustic channels. As the transmission scheme shown in FIG. 2 is the preferred one due to its higher diversity (fourth order) over the lower diversity (second order) of the transmission scheme shown in FIG. 3, another aspect of the disclosure that is described in the following (below with respect to FIG. 4) is to combine both configurations in an adaptive manner in order to improve diversity and mitigate audible artifacts. The idea is to use the transmission scheme of FIG. 2 as long as no audible artifacts occur and to only switch to the transmission scheme of FIG. 3 when audible artifacts are detected. For detection of such audible artifacts a microphone can be applied. The details are described below with respect to FIG. 4.

FIG. 4 is a schematic diagram illustrating an ultrasonic communication system 400 according to the disclosure. The idea is to add a microphone 403 to the loudspeaker device 101 depicted in FIG. 1 to generate an audio signal 402 for measuring the audible artifacts 408, 410 produced by the non-linear transmission effects. A controller 407 can be used to adjust the transmission based on a dynamic scheme 405 depending on the audio signal 402. The dynamic scheme may for example switch transmission between a first transmission scheme, for example the scheme according to FIG. 2, and a second transmission scheme, for example the scheme according to FIG. 3. Depending on the decision of the controller 407 audio signals 404, 406 (corresponding to audio signals 306, 308 for the transmission scheme of FIG. 3 or corresponding to the audio signal 208 for the transmission scheme of FIG. 2) are provided to the loudspeakers 103, 104 for improving ultrasonic communication with the mobile device 105, i.e. ultrasonic communication in which audible artifacts are mitigated or suppressed, at least non-bearable.

The audio signal 402 can have different channel components, for example a first channel component for transmission to a first loudspeaker 103 and a second channel component for transmission to a second loudspeaker 104. Alternatively, the loudspeaker device 401 may have a single loudspeaker or more than two loudspeakers (not shown in FIG. 4).

The microphone 403 may be arranged in proximity to the loudspeaker device 401 or integrated in the loudspeaker device 401. The loudspeaker device 401 may include two loudspeakers 103, 104 as shown in FIG. 4 or alternatively any other number of loudspeakers. The microphone 403 may be placed between the two loudspeakers 103, 104 to record the audible artifacts 408, 410 with high precision.

The ultrasonic communication device 401 communicating with the mobile device 105 via ultrasound 102 includes an adjustable ultrasonic transmitter, e.g. formed by the loudspeakers 103, 104, a microphone 403 and a controller 407.

The adjustable ultrasonic transmitter 103, 104 transmits an ultrasonic communication signal 102 according to a first transmission scheme (e.g. according to the configuration of FIG. 2) or according to a second transmission scheme (e.g. according to the configuration of FIG. 3). The microphone 403 generates an audio signal 402 which includes audible artifacts 408, 410 which are based on nonlinearities in the transmission of the ultrasonic communication signal 102. The controller 407 adjusts the ultrasonic transmitter 103, 104 based on the audio signal 402. The controller 407 may implement a dynamic scheme 405 for dynamic switching between the first and the second transmission schemes.

The ultrasonic communication device 401 may include an audio codec for encoding data based on dual tone multiple frequency (DTMF) modulation to generate the ultrasonic communication signal, e.g. as described below with respect to FIG. 5. The ultrasonic communication signal 102 may include a first ultrasonic tone (e.g. a first frequency tone f1 shown in FIGS. 2 and 3) and a second ultrasonic tone (e.g. a second frequency tone f2 shown in FIGS. 2 and 3), that may be generated according to the DTMF scheme shown in FIG. 5. The ultrasonic transmitter 103, 104 may transmit the first ultrasonic tone and the second ultrasonic tone simultaneously.

To implement the first transmission scheme (e.g. according to FIG. 2), the ultrasonic transmitter may include a mixer 203 configured to superimpose the first ultrasonic tone 202 and the second ultrasonic tone 204 for simultaneous transmission through a first acoustic channel 103 and a second acoustic channel 104, i.e. the both loudspeakers 103, 104.

To implement the second transmission scheme (e.g. according to FIG. 3), the ultrasonic transmitter may generate the first ultrasonic tone 202 for transmission through the first acoustic channel 103 and may generate the second ultrasonic tone 204 for transmission through the second acoustic channel 104.

The controller 407 may determine a quality measure based on the audible artifacts 408, 410 generated by the microphone 403. The controller 407 may adjust the ultrasonic transmitter for transmission according to the first transmission scheme or to the second transmission scheme based on the quality measure.

The controller 407 may control the ultrasonic transmitter transmitting a pilot tone and may control the microphone 403 generating an audio signal 402 response of the pilot tone.

The quality measure may for example be based on an average energy of the audio signal 402 generated by the microphone 403. The controller 407 may adjust the ultrasonic transmitter for transmission according to the second transmission scheme if the quality measure falls below a threshold. The ultrasonic communication signal may for example include a personal identification number (PIN).

Adaptively configuring ultrasonic transmissions as described above will enable a larger range of TV and speaker manufacturers the ability to install an ultrasound proximity solution. This can improve wireless displays such as Unite and wireless docking.

FIG. 5 is a schematic diagram illustrating a Gray code mapping and DTMF decoding table 500 for generating DTMF modulated ultrasonic communication signals according to the disclosure. The table 500 includes eight times eight, i.e. 64 frequency combinations in the ultrasonic range, for each frequency combination a specific Gray code is applied. The first tone fc ranges from 18971 Hz to 19650 Hz and the second tone fr ranges from 18194 Hz to 18874 Hz.

In a Dual Tone Multiple Frequency, DTMF, communication link, e.g. as illustrated in FIG. 5 two frequency waves (fc and fr) are transmitted simultaneously. Most modern devices are equipped with two-channel, two-speaker audio systems. This allows for flexibility in constructing the DTMF signals for ultrasound communications. Either the two frequency components are superimposed and transmitted through both left and right channels as illustrated in FIG. 2, or one tone is sent through the left channel, and the other tone is sent through the right channel as illustrated in FIG. 3. The two options have different advantage and disadvantages depending on the design of the speakers or audio codecs of the device. A method to choose which option has the least impact on performance and user experience can be accomplished by equipping the ultrasound transmitter with a microphone as described above with respect to FIG. 4. The transmitter will be able to listen to its own output, and determine if the audio system's nonlinearities at high frequencies or audio codecs create audible artifacts and adjust the transmission properties adaptively.

Smart Office conference room's PC/NUC of today have the necessary components to implement the adaptive transmission algorithm. Two-channel, two-speaker playback audio may be enabled via HDMI connection to a stereo TV. A desktop microphone may be inserted to the 3.5 mm audio jack and strategically placed near the TV's audio output, e.g. as shown in the configuration of FIG. 4. Sampling rates of both speakers and microphone should be at least 44.1 kHz.

Two tones are transmitted simultaneously for DTMF modulation. Transmitter performance in the 18-20 kHz band and the user experience may be effected due to variability in speaker and audio drivers across manufacturers.

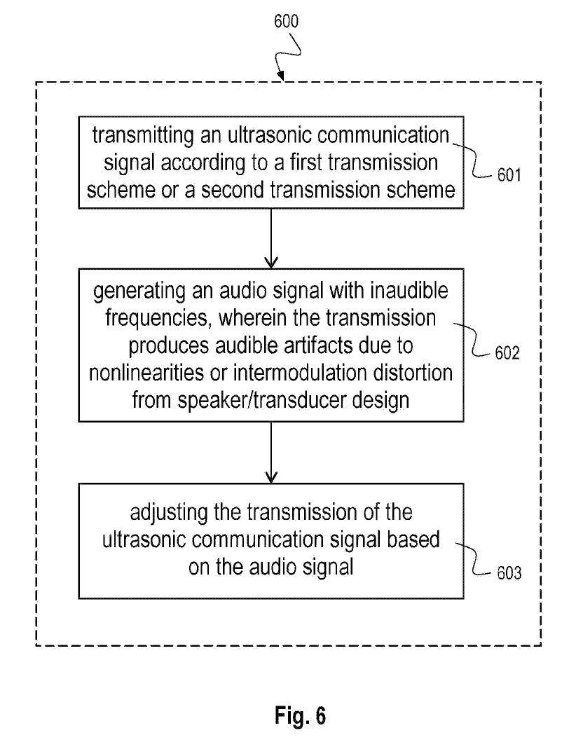

FIG. 6 is a schematic diagram illustrating a method 600 for ultrasonic communication according to the disclosure. The method 600 may correspond to the configuration shown above with respect to FIG. 4.

The method 600 includes transmitting 601 an ultrasonic communication signal according to a first transmission scheme or according to a second transmission scheme. The method 600 includes generating 602 an audio signal with inaudible frequencies, wherein the transmission produces audible artifacts due to nonlinearities or inter modulation distortion from speaker/transducer design. The method 600 further includes adjusting 603 the transmission of the ultrasonic communication signal based on the audio signal.

The method 600 may further include encoding data based on dual tone multiple frequency (DTMF) modulation to generate the ultrasonic communication signal. The ultrasonic communication signal may include a first ultrasonic tone and a second ultrasonic tone as described above with respect to FIGS. 2 to 4. The method 600 may include transmitting the first ultrasonic tone and the second ultrasonic tone simultaneously.

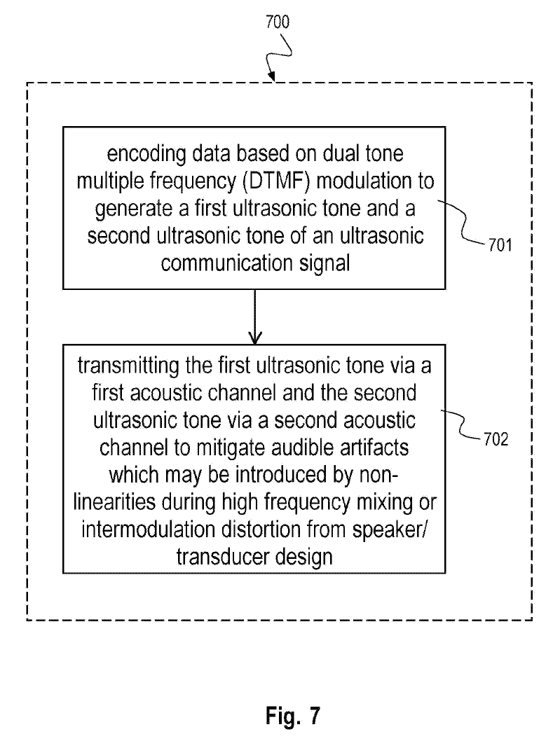

FIG. 7 is a schematic diagram illustrating a method 700 for ultrasonic communication according to the disclosure. The method 700 may correspond to the configuration shown above with respect to FIG. 3.

The method 700 includes encoding 701 data based on dual tone multiple frequency (DTMF) modulation to generate a first ultrasonic tone and a second ultrasonic tone of an ultrasonic communication signal. The method 700 further includes transmitting 702 the first ultrasonic tone via a first acoustic channel and the second ultrasonic tone via a second acoustic channel to mitigate audible artifacts which may be introduced by nonlinearities during high frequency mixing or inter modulation distortion from speaker/transducer design.

The method 700 may further include isolating the first ultrasonic tone from the second ultrasonic tone to avoid intermodulation distortion. The method 700 may further include transmitting the first ultrasonic tone and the second ultrasonic tone simultaneously.

The devices and systems described in this disclosure may be implemented as Digital Signal Processors (DSP), micro-controllers or any other side-processor or hardware circuit on a chip or an application specific integrated circuit (ASIC).

Embodiments described in this disclosure can be implemented in digital electronic circuitry, or in computer hardware, firmware, software, or in combinations thereof, e.g. in available hardware of mobile devices or in new hardware dedicated for processing the methods described herein.

The present disclosure also supports a computer program product including computer executable code or computer executable instructions that, when executed, causes at least one computer to execute the performing and computing blocks described herein, in particular the methods 600, 700 described above with respect to FIGS. 6 and 7 and the computing blocks described above with respect to FIGS. 2 to 4. Such a computer program product may include a non-transient readable storage medium storing program code thereon for use by a processor, the program code comprising instructions for performing the methods 600, 700 or the computing blocks as described above.

### Examples

The following examples pertain to further embodiments. Example 1 is an ultrasonic communication device, comprising: an adjustable ultrasonic transmitter, configured to transmit an ultrasonic communication signal according to a first transmission scheme or according to a second transmission scheme; a microphone, configured to generate an audio signal, wherein the audio signal comprises audible artifacts which are based on nonlinearities in the transmission of the ultrasonic communication signal; and a controller, configured to adjust the ultrasonic transmitter based on the audio signal.

In Example 2, the subject matter of Example 1 can optionally include: an audio codec, configured to encode data based on dual tone multiple frequency (DTMF) modulation to generate the ultrasonic communication signal.

In Example 3, the subject matter of any one of Examples 1-2 can optionally include that the ultrasonic communication signal comprises a first ultrasonic tone and a second ultrasonic tone.

In Example 4, the subject matter of Example 3 can optionally include that the ultrasonic transmitter is configured to transmit the first ultrasonic tone and the second ultrasonic tone simultaneously.

In Example 5, the subject matter of Example 4 can optionally include that the ultrasonic transmitter comprises a mixer configured to superimpose the first ultrasonic tone and the second ultrasonic tone for simultaneous transmission through a first acoustic channel and a second acoustic channel when using the first transmission scheme.

In Example 6, the subject matter of any one of Examples 4-5 can optionally include that the ultrasonic transmitter is configured to generate the first ultrasonic tone for transmission through a first acoustic channel and to generate the second ultrasonic tone for transmission through a second acoustic channel when using the second transmission scheme.

In Example 7, the subject matter of any one of Examples 1-6 can optionally include that the controller is configured to determine a quality measure based on the audible artifacts generated by the microphone.

In Example 8, the subject matter of Example 7 can optionally include that the controller is configured to adjust the ultrasonic transmitter for transmission according to the first transmission scheme or to the second transmission scheme based on the quality measure.

In Example 8, the subject matter of Example 8 can optionally include that the controller is configured to control the ultrasonic transmitter transmitting a pilot tone and to control the microphone generating an audio signal response of the pilot tone.

In Example 10, the subject matter of any one of Examples 7-9 can optionally include that the quality measure is based on an average energy of the audio signal generated by the microphone.

In Example 11, the subject matter of any one of Examples 7-10 can optionally include that the controller is configured to adjust the ultrasonic transmitter for transmission according to the second transmission scheme if the quality measure falls below a threshold.

In Example 12, the subject matter of any one of Examples 1-11 can optionally include that the ultrasonic communication signal comprises a personal identification number (PIN).

Example 13 is an ultrasonic communication device, comprising: an audio codec, configured to encode data based on dual tone multiple frequency (DTMF) modulation to generate a first ultrasonic tone and a second ultrasonic tone of an ultrasonic communication signal; and an ultrasonic transmitter, configured to transmit the first ultrasonic tone via a first acoustic channel and the second ultrasonic tone via a second acoustic channel to mitigate audible artifacts which are based on nonlinearities in the transmission of the ultrasonic communication signal.

In Example 14, the subject matter of Example 13 can optionally include that the ultrasonic transmitter is configured to isolate the first ultrasonic tone from the second ultrasonic tone to avoid intermodulation distortion.

In Example 15, the subject matter of any one of Examples 13-14 can optionally include that the ultrasonic transmitter is configured to transmit the first ultrasonic tone and the second ultrasonic tone simultaneously.

In Example 16, the subject matter of any one of Examples 13-15 can optionally include that the ultrasonic transmitter comprises: a first amplifier and a first loudspeaker which are configured to transmit the first ultrasonic tone; and a second amplifier and a second loudspeaker which are configured to transmit the second ultrasonic tone.

In Example 17, the subject matter of Example 16 can optionally include: a stereo TV, configured to playout the first ultrasonic tone through the first loudspeaker and the second ultrasonic tone through the second loudspeaker.

In Example 18, the subject matter of any one of Examples 13-17 can optionally include: an external interface configured to receive the data.

In Example 19, the subject matter of Example 18 can optionally include that the external interface comprises a High Definition Multimedia Interface (HDMI) connection.

In Example 20, the subject matter of any one of Examples 13-19 can optionally include that the ultrasonic communication signal comprises a personal identification number (PIN).

Example 21 is an ultrasonic communication system, comprising: an adjustable ultrasonic transmitter, configured to transmit an ultrasonic communication signal according to a first transmission scheme or according to a second transmission scheme; a microphone, configured to generate an audio signal, wherein the audio signal comprises audible artifacts which are based on nonlinearities in the transmission of the ultrasonic communication signal; and a controller, configured to adjust the ultrasonic transmitter based on the audio signal.

In Example 22, the subject matter of Example 21 can optionally include: an audio codec, configured to encode data based on dual tone multiple frequency (DTMF) modulation to generate the ultrasonic communication signal.

In Example 23, the subject matter of any one of Examples 21-22 can optionally include that the ultrasonic communication signal comprises a personal identification number (PIN) for registering a user with the ultrasonic communication system.

Example 24 is a method for ultrasonic communication, the method comprising: transmitting an ultrasonic communication signal according to a first transmission scheme or according to a second transmission scheme; generating an audio signal with inaudible frequencies, wherein the transmission produces audible artifacts due to nonlinearities or intermodulation distortion from speaker-transducer design; and adjusting the transmission of the ultrasonic communication signal based on the audio signal.

In Example 25, the subject matter of Example 24 can optionally include: encoding data based on dual tone multiple frequency (DTMF) modulation to generate the ultrasonic communication signal.

In Example 26, the subject matter of any one of Examples 24-25 can optionally include that the ultrasonic communication signal comprises a first ultrasonic tone and a second ultrasonic tone.

In Example 27, the subject matter of any one of Examples 24-26 can optionally include: transmitting the first ultrasonic tone and the second ultrasonic tone simultaneously.

Example 28 is a device for ultrasonic communication, the device comprising: means for transmitting an ultrasonic communication signal according to a first transmission scheme or according to a second transmission scheme; means for generating an audio signal, wherein the audio signal comprises audible artifacts which are based on nonlinearities in the transmission of the ultrasonic communication signal; and means for adjusting the transmission of the ultrasonic communication signal based on the audio signal.

In Example 29, the subject matter of Example 28 can optionally include: means for encoding data based on dual tone multiple frequency (DTMF) modulation to generate the ultrasonic communication signal.

Example 30 is a method for ultrasonic communication, the method comprising: encoding data based on dual tone multiple frequency (DTMF) modulation to generate a first ultrasonic tone and a second ultrasonic tone of an ultrasonic communication signal; and transmitting the first ultrasonic tone via a first acoustic channel and the second ultrasonic tone via a second acoustic channel to mitigate audible artifacts which are introduced by nonlinearities during high frequency mixing or intermodulation distortion from speaker-transducer design.

In Example 31, the subject matter of Example 30 can optionally include: isolating the first ultrasonic tone from the second ultrasonic tone to avoid intermodulation distortion.

In Example 32, the subject matter of any one of Examples 30-31 can optionally include: transmitting the first ultrasonic tone and the second ultrasonic tone simultaneously.

Example 33 is a computer readable non-transitory medium on which computer instructions are stored which when executed by a computer cause the computer to perform the method of any one of Examples 24 to 27 or 30 to 32.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1. An ultrasonic communication device, comprising:
an adjustable ultrasonic transmitter, configured to transmit an ultrasonic communication signal according to a first transmission scheme or according to a second transmission scheme;
a microphone, configured to record the transmitted ultrasonic communication signal and capture any audible artifacts which are a result of nonlinearities in a transmission chain of the ultrasonic communication signal; and
a controller, configured to adjust the ultrasonic transmitter based on the audio artifacts.

2. The ultrasonic communication device of claim 1, comprising:
an audio playback device, configured to encode data based on dual tone multiple frequency (DTMF) modulation to generate the ultrasonic communication signal.

3. The ultrasonic communication device of claim 1,
wherein the ultrasonic communication signal comprises a first ultrasonic tone and a second ultrasonic tone.

4. The ultrasonic communication device of claim 3,
wherein the ultrasonic transmitter is configured to transmit the first ultrasonic tone and the second ultrasonic tone simultaneously.

5. The ultrasonic communication device of claim 4,
wherein the ultrasonic transmitter comprises a mixer configured to superimpose the first ultrasonic tone and the second ultrasonic tone for simultaneous transmission through a first acoustic channel and a second acoustic channel when using the first transmission scheme.

6. The ultrasonic communication device of claim 4,
wherein the ultrasonic transmitter is configured to generate the first ultrasonic tone for transmission through a first acoustic channel and to generate the second ultrasonic tone for transmission through a second acoustic channel when using the second transmission scheme.

7. The ultrasonic communication device of claim 1,
wherein the controller is configured to determine a quality measure based on the audible artifacts.

8. The ultrasonic communication device of claim 7,
wherein the controller is configured to adjust the ultrasonic transmitter for transmission according to the first transmission scheme or to the second transmission scheme based on the quality measure.

9. The ultrasonic communication device of claim 8,
wherein the controller is configured to control the ultrasonic transmitter transmitting a pilot packet and to analyze the microphone recording a response of the pilot packet.

10. The ultrasonic communication device of claim 7,
wherein the quality measure is based on an average energy of the audible artifact generated by the transmit chain.

11. The ultrasonic communication device of claim 7,
wherein the controller is configured to adjust the ultrasonic transmitter for transmission according to the second transmission scheme if the quality measure exceeds a threshold.

12. The ultrasonic communication device of claim 1,
wherein the ultrasonic communication signal comprises a personal identification number (PIN).

13. An ultrasonic communication device, comprising:
an audio playback device, configured to encode data based on dual tone multiple frequency (DTMF) modulation to generate a first ultrasonic tone and a second ultrasonic tone of an ultrasonic communication signal;
an ultrasonic transmitter, configured to transmit the first ultrasonic tone via a first acoustic channel and the second ultrasonic tone via a second acoustic channel to mitigate any audible artifacts which are a result of nonlinearities in a transmission chain of the ultrasonic communication signal.

14. The ultrasonic communication device of claim 13,
wherein the ultrasonic transmitter is configured to isolate the first ultrasonic tone from the second ultrasonic tone in the transmitter to avoid intermodulation distortion.

15. The ultrasonic communication device of claim 13,
wherein the ultrasonic transmitter is configured to transmit the first ultrasonic tone and the second ultrasonic tone simultaneously.

16. The ultrasonic communication device of claim 13, wherein the ultrasonic transmitter comprises:
a first amplifier and a first loudspeaker which are configured to transmit the first ultrasonic tone; and
a second amplifier and a second loudspeaker which are configured to transmit the second ultrasonic tone.

17. The ultrasonic communication device of claim 16, comprising:
a stereo TV, configured to playout the first ultrasonic tone through the first loudspeaker and the second ultrasonic tone through the second loudspeaker.

18. The ultrasonic communication device of claim 13, comprising:
an external interface configured to receive the data.

19. The ultrasonic communication device of claim 18,
wherein the external interface comprises a High Definition Multimedia Interface (HDMI) connection.

20. The ultrasonic communication device of claim 13,
wherein the ultrasonic communication signal comprises a personal identification number (PIN).

21. A method for ultrasonic communication, the method comprising:
transmitting an ultrasonic communication signal according to a first transmission scheme or according to a second transmission scheme;
recording the transmitted ultrasonic signal with inaudible frequencies and capturing any audible artifacts due to nonlinearities or intermodulation distortion from speaker-transducer design; and
adjusting the transmission of the ultrasonic communication signal based on the audio artifacts.

22. The method of claim 21, comprising:
encoding data based on dual tone multiple frequency (DTMF) modulation to generate the ultrasonic communication signal.

23. The method of claim 21,
wherein the ultrasonic communication signal comprises a first ultrasonic tone and a second ultrasonic tone.

24. A method for ultrasonic communication, the method comprising:
encoding data based on dual tone multiple frequency (DTMF) modulation to generate a first ultrasonic tone and a second ultrasonic tone of an ultrasonic communication signal; and
transmitting the first ultrasonic tone via a first acoustic channel and the second ultrasonic tone via a second acoustic channel to mitigate audible artifacts which are introduced by nonlinearities in a transmission chain of the ultrasonic communication signal during high frequency mixing or intermodulation distortion from speaker-transducer design.

25. The method of claim 24, comprising:
isolating the first ultrasonic tone from the second ultrasonic tone in the transmitter to avoid intermodulation distortion.
